(19) United States
(12) Patent Application Publication
(10) Pub. No.: US 2003/0057232 A1
(43) Pub. Date: Mar. 27, 2003

(54) Apparatus for producing hygiene products

(76) Inventor: Albert Becker, Ehlscheid (DE)

Correspondence Address: FASSE PATENT ATTORNEYS, P.A., P.O. BOX 726, HAMPDEN, ME, 04444-0726, US

(21) Appl. No.: 10/232,947

(22) Filed: Aug. 30, 2002

(30) Foreign Application Priority Data
Sep. 4, 2001 (DE) 101 44 028.6

(51) Int. Cl. B67D 5/10; G07F 13/00; B65H 1/00

(52) U.S. Cl. 222/2; 221/198

(57) ABSTRACT

An apparatus for producing hygiene products includes several stations (2) with at least partially differing machine components (3) and predominantly separate independent drives (4). The machine components (3) and the drives (4) are assembled together on carrier plates (9) to form assembly units, and are securely mountable in a machine frame, which includes vertical upright supports (18) and horizontal connecting struts (17, 19, 20). The assembly units are provided as small modules (10) assembled from the machine components (3), drives (4) and carrier plates (9), which in turn at least partially are assembled together to form large modules (12) in the manner of large assembly units, which further in turn are assembled and connected together to form the apparatus including the machine frame, the machine components (3), and their drives (4).

### PRIORITY CLAIM

This application is based on and claims the priority under 35 U.S.C. §119 of German Patent Application 101 44 028.6, filed on Sep. 4, 2001, the entire disclosure of which is incorporated herein by reference.

### FIELD OF THE INVENTION

The invention relates to an apparatus for producing hygiene products, and includes several stations with at least partially differing machine components, which predominantly are associated with their own independent drives. It is further characteristic of an apparatus of such type, that the machine components, partially or entirely, and their drives, are assembled together on carrier plates to form assembly units, and are securable on a machine frame, which comprises vertical upright supports and horizontal connecting struts or braces.

### BACKGROUND INFORMATION

The separation or distribution of the machine components and their drives into a plurality of different assembly units or installation units, which respectively also comprise carrier plates, achieves various advantages. The individual assembly units can be produced independently of one another, and can then be integrated into the supporting framework serving as the carrier for the machine units. In this respect, advantages are achieved in the production technology. These production technology advantages can only be achieved, however, if the carrier plates are normalized or standardized. The standardization of the carrier plates is, however, associated not only with advantages, but also with disadvantages for the machine frame, which generally consists of a great number of vertical upright supports or columns and horizontal connecting struts or braces, arranged on a frame bed or base formed by a base plate.

Most importantly, the dynamic forces arising in the event of an emergency stop of the machinery, in connection with the typical static forces, are considerable, and thus require a significant strength, and thus a considerable effort and complexity involved in the structure and construction of the machine frame to adequately support these force loads.

### SUMMARY OF THE INVENTION

In view of the above, it is an object of the invention to achieve optimal conditions for the assembly and installation as well as for the disassembly of the apparatus and/or of individual components of the apparatus in the case of repairs or in the case of necessary reconfiguration work, without thereby losing the necessary strength and stiffness of the machine frame which serves as a carrier for the machine components and the drives thereof. The invention further aims to avoid or overcome the disadvantages of the prior art, and to achieve additional advantages, as apparent from the present specification. These objects, however, are not a limitation of the claimed invention.

The above objects have been achieved according to the invention in an apparatus for producing hygiene products, comprising several stations with at least partially different machine components as well as with predominantly independent drives, whereby respective machine components and drives are grouped or assembled together on carrier plates to form assembly units or installation units and are securely mountable in a machine frame, which comprises vertical upright supports or columns and horizontal connection struts or braces. Further, and particularly according to the invention, the assembly units that respectively include machine components and drives mounted on carrier plates are provided in the form of small modules, which are then in turn further grouped and assembled together into larger assembly units respectively in the form of large modules. The resulting large modules that are equipped with or assembled from the small modules are then connectable (and are ultimately so connected) with each other to form the overall apparatus which includes the machine frame, the machine components, and their drives. The terms “small module” and “large module” are intended to be understood relative to each other, so that a “large module” is larger than a “small module” and includes a plurality of joined small modules.

According to the invention, thus also parts of the machine frame respectively belong to a large module, just the same as various machine components and drives. Correspondingly, each large module comprises an assembly frame or framework as a carrier, whereby the assembly framework has a carrying or support function in the same manner as the carrier plates in the case of the small modules.

In a further development of the invention, it is provided that the assembly framework of the large module comprises frame elements with short horizontally lying struts or braces, and long vertically arranged upright supports or columns, as well as struts or braces that interconnect these upright supports in the machine longitudinal direction.

### BRIEF DESCRIPTION OF THE DRAWINGS

In order that the invention may be clearly understood, it will now be described in connection with example embodiments, with reference to the accompanying drawings, wherein:

FIG. 1 is a schematic, partially separated or exploded view of several small modules and large modules of an apparatus for producing hygiene products according to the invention;

FIG. 2 is a perspective view with a larger scale, of three small modules comprising machine components and carrier plates respectively serving as a carrier;

FIG. 3 is a view, with a smaller scale, of an assembly framework serving as a carrier of a large module;

FIG. 4 is a top plan view of the assembly framework;

FIG. 5 is a perspective view of the assembly framework from the front, in a once again smaller scale;

FIG. 6 is a perspective view of the assembly framework from the rear;

FIG. 7 is a perspective view of the assembly framework as in FIG. 5, together with an electrical cabinet;

FIG. 8 is a side view of the assembly framework with the electrical cabinet in a smaller scale; and

FIG. 9 is a perspective view as in FIG. 7, with two different assembly frameworks.

### DETAILED DESCRIPTION OF PREFERRED EXAMPLE EMBODIMENTS AND OF THE BEST MODE OF THE INVENTION

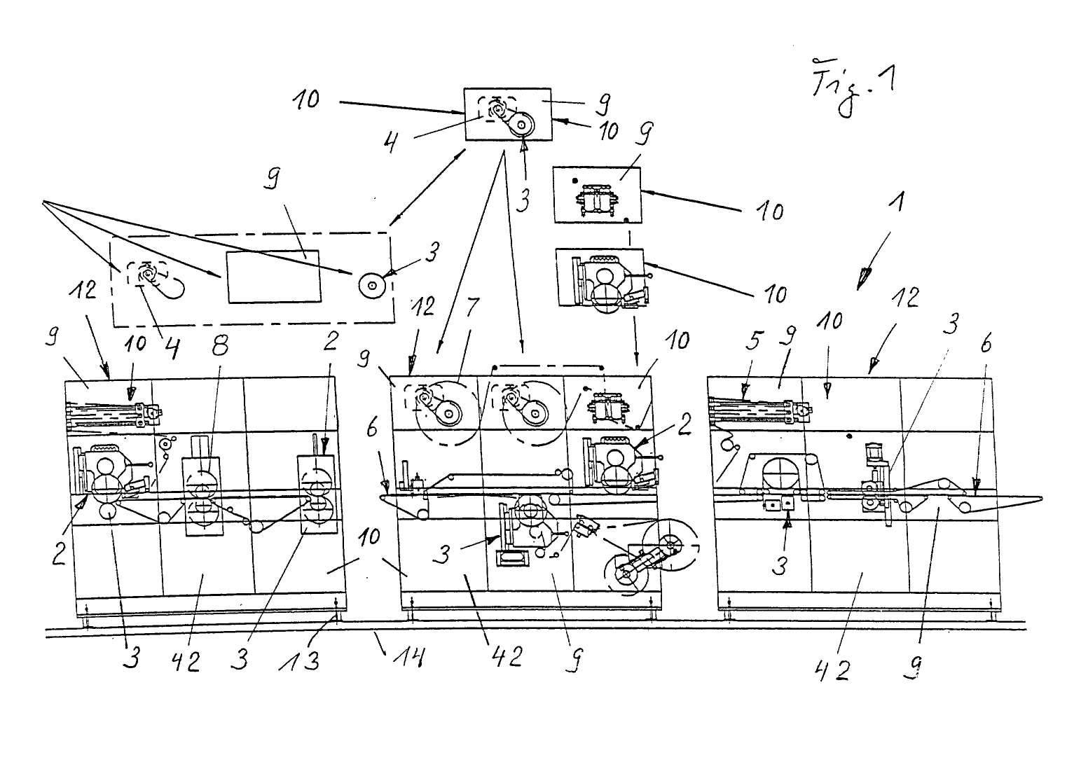

An apparatus 1 for producing hygiene products, which is only partially shown in FIG. 1, comprises, depending on respective requirements, several stations 2 with at least partially differing machine components 3 as well as with predominantly individual independent drives 4. The machine components 3 may, for example, comprise storage or reserve elements 5, transport devices 6, unrolling devices 7, crosswise cutting devices 8, folding devices, and/or gluing devices, and so forth, for respectively successively processing various material webs and/or sheets to form thereof successive hygiene products such as facial tissues, disposable towels, diapers, incontinence pads, feminine sanitary napkins or pads, and the like. These machine components 3 and the drive 4 are arranged and assembled together in groups on carrier plates 9 and thereby form respective assembly units, depending on the respective requirements, whereby these assembly units respectively each form a small module 10.

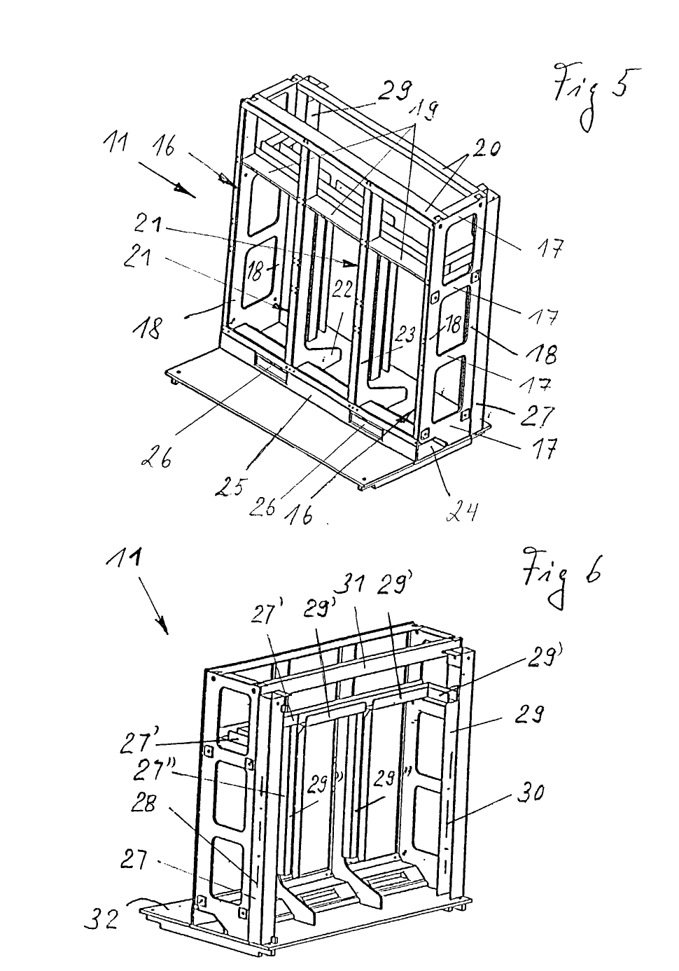

A respective assembly framework 11 (see FIG. 5) is provided as a carrier for several small modules 10. The assembly framework 11 together with the small modules 10 respectively forms a large module 12.

Further, in turn, the large modules 12 equipped or provided with small modules 10 can be connected to each other (and are ultimately so connected) to form the apparatus 1, which thus generally comprises the machine frame, the machine components 3, and the drives 4. To that end, the large modules 12 are screwed together with each other. With the aid of adjustable feet 13, they may first be properly oriented or leveled on a floor 14 (see FIG. 1).

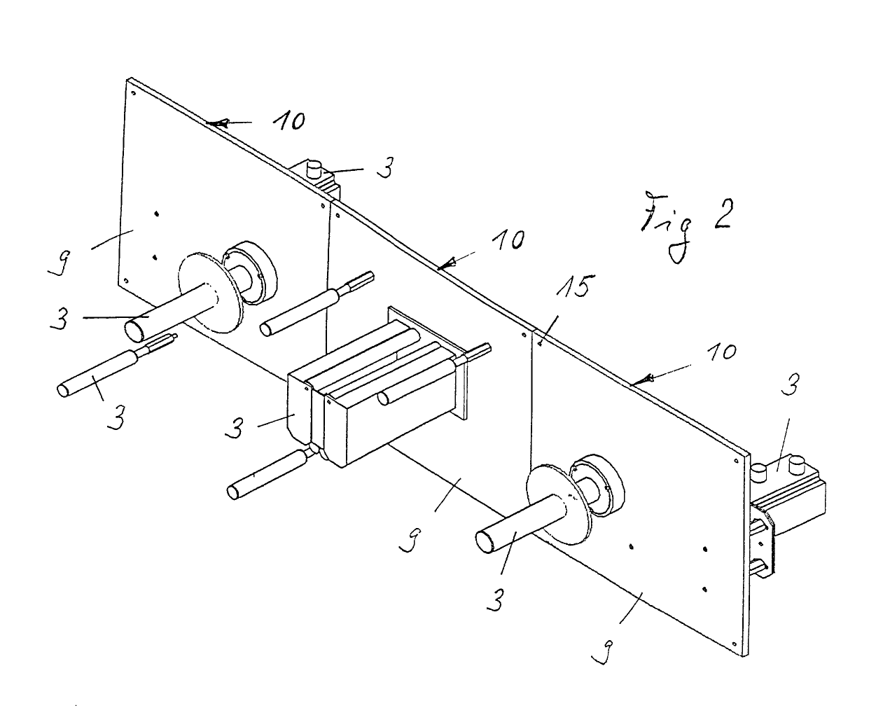

The mounting and securing of the carrier plates 9 of the small modules 10 on the assembly frames or frameworks 11 of the large modules 12 is achieved with the aid of screws and securing openings or holes 15 in the carrier plates 9 (see FIG. 2).

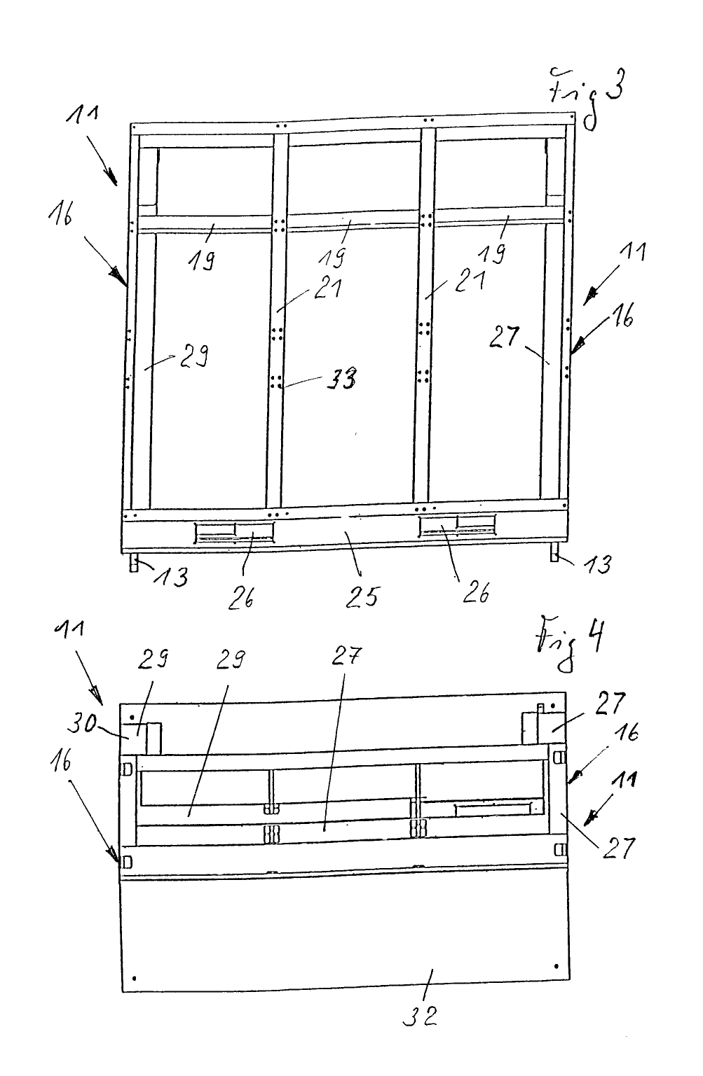

According to the illustrations in the FIGS. 3 to 6, the assembly framework 11 comprises frame elements 16 extending crosswise or perpendicularly to the machine longitudinal direction, with short horizontal struts or braces 17 and with long vertically arranged upright supports or columns 18 as well as lengthwise struts or braces 19 and 20 that connect the upright supports 18 in the machine longitudinal direction. Further, at least one L-shaped frame member 21 is provided extending crosswise or perpendicularly to the machine lengthwise direction, and comprises a short shank 22 arranged on the floor side and a vertically extending upright strut or brace 23.

According to the example embodiment illustrated in the FIGS. 5 and 6, two frame members 21 are located between the frame elements 16 forming the ends of the assembly framework 11.

The rectangular frame elements 16 and the L-shaped frame members 21 are respectively integral one-piece elements.

Furthermore, the rectangular frame elements 16 and the L-shaped frame members 21 respectively comprise, on the floor side, a recess 24 for an air conveying channel 25. The air conveying channel 25 is open at its ends, and furthermore comprises additional air holes or openings 26 between its ends.

The air conveying channel 25 is integrated into the assembly framework 11 as an element that increases the strength and stiffness thereof, in a similar manner as further, horizontally and vertically arranged cable channels 27 and 29.

The assembly framework 11 of the large module 12 comprises horizontally and vertically arranged cable channels 27 for electrical control lines 28 and separately therefrom, horizontally and vertically arranged cable channels 29 for electrical lines 30 serving for the electrical power supply. Both the cable channels 27 as well as the cable channels 29 consist of cable channel segments or pieces, and are easily accessible at several locations.

On the rear or back side 31 of the assembly framework 11, a vertically oriented cable channel 27 extends on one end as well as flushly with the one frame element 16, and on the other end, a vertically oriented cable channel 29 similarly extends from a base or floor plate 32 up to the upper end of the assembly framework 11. The horizontally oriented cable channel segments or pieces 27′ and 29′ are arranged approximately in the upper one-fourth or one-quarter, and similarly, vertically oriented cable channel segments or pieces 27″ and 29″ extend downwardly therefrom.

The cable channels 27 and 29, and correspondingly their cable channel segments or pieces, are embodied and structured in such a manner so that they simultaneously provide a carrying or supporting function.

The air conveying channel 25 and in a similar manner the cable channel 27 provided for the control lines 28 and the cable channel 29 provided for the electrical lines for the power supply, or their respective cable channel segments or pieces, consist of steel, due to their simultaneous carrying or supporting function. They have a material thickness that is approximately 2.5 mm larger than the material thickness of such channels without a carrying or supporting function.

Both the externally located frame elements 16 as well as the frame elements 21 arranged therebetween comprise securing holes or openings 33 at defined locations for securing the carrier plates 9 of the small modules 10 with the aid of screws, which are not shown in the drawings.

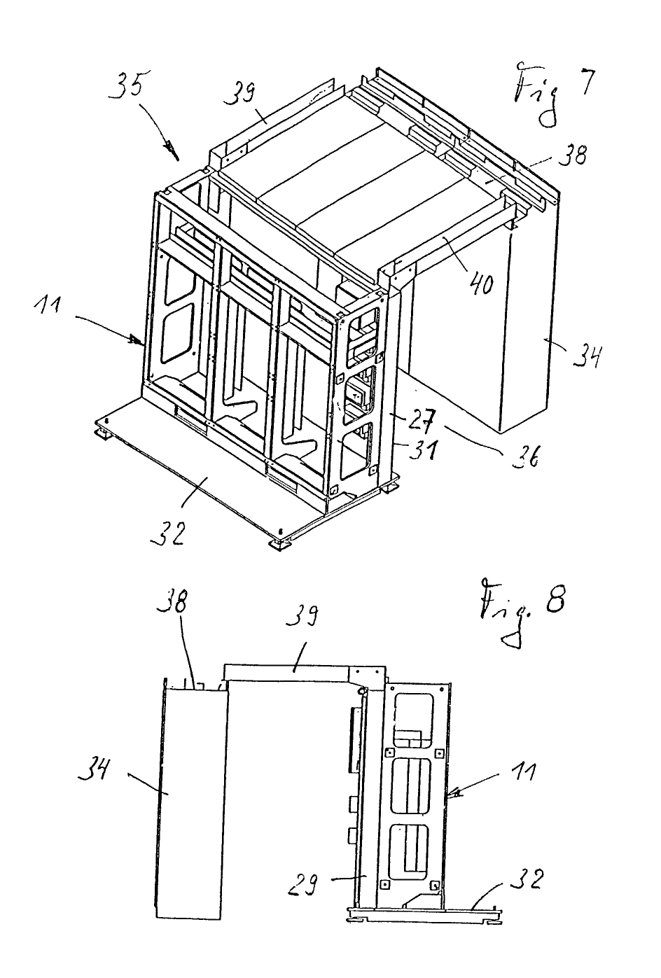

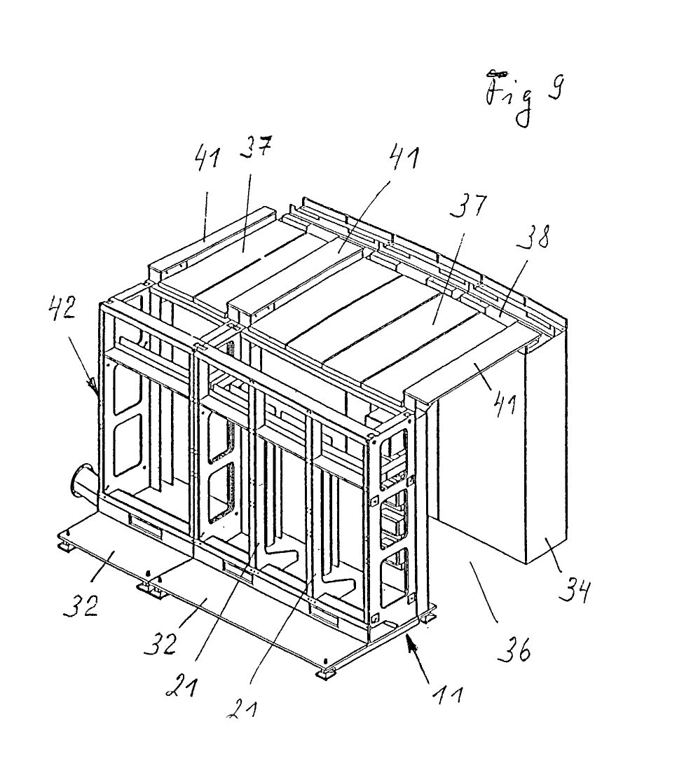

Finally, an electrical cabinet arranged at a spacing away from the assembly framework 11 and on its rear or back side 31, together with the assembly framework itself, forms a structural unit 35 (see FIG. 7). The spacing distance between the assembly framework 11 and the parallel-standing electrical cabinet 34 can be dimensioned in such a manner, so that a walkway or passage 36 is formed therebetween. Moreover, ceiling panels or elements 37, which increase the strength and stability, interconnect, at the top, the rear or back side 31 of the assembly framework 11 with the cover 38 of the electrical cabinet 34. Simultaneously, cable channels 39 and 40 bridge over the passage or walkway 36 and connect the respective cable channels 27 and 29 with corresponding inlet locations or access holes on the electrical cabinet or cabinets 34. The cable channels 39 and 40 also have a function of increasing the strength and supporting capacity of the assembly framework or respectively of the large module 12.

According to the example embodiment illustrated in FIG. 9, the cable channels 39 and 40, which have a U-shaped cross-section, are covered with the aid of cover plates or panels 41.

Further according to FIG. 9, an additional assembly framework 42 without L-shaped frame members 21 stands next to an assembly framework 11 comprising two L-shaped frame members 21. The invention is thus not limited to large modules 12 with assembly frameworks 11 which respectively comprise two frame members 21.

The inventive arrangement further may include space holder panels or plates 43 similar to the carrier plates 9, but without a carrier function. That is to say, the space holder panels or plates 43 are blank plates that do not carry any machine components or the like thereon, but instead simply hold or fill an otherwise blank space and provide an interconnection and reinforcement of the respective adjacent frame parts.

Moreover, it should basically be understood, that respective grid pattern dimensions are provided for the carrier plates 9 and also for the space holder plates 43, so that these plates 9 and 43 can be arranged and assembled together in a sensible, rational and purposeful manner to form the large modules 12. The especially sensible and useful dimensions according to the invention, i.e. the preferred grid pattern dimensions for the carrier plates and for the space holder plates, are:

a) 1200 mm×700 mm

b) 1200 mm×500 mm

c) 1200 mm×230 mm

d) 800 mm×700 mm

e) 800 mm×500 mm

f) 800 mm×230 mm.

The machine frame of the apparatus 1 consists of the sum total or overall assembly of the assembly frameworks 11, carrier plates 9, and space holder plates 43, respectively connected with one another.

Electrical control and regulating lines lead from the machine components 3 and drives 4 on the carrier plates 9 to the respective cable channel segments or pieces, or the respective cable channels 27, and are there respectively individually laid out along the channels and are then connected with connector elements at the ends of the channels, depending on the particular situation, so that the assembly frameworks can finally be assembled and interconnected together quickly and easily as large modules. The arrangement of the cable channels 27 and 29 is selected in this context, so as to enable an arrangement of the electrical lines that is both rationally interconnected as well as providing a good oversight and access, while increasing or contributing to the strength and stability of the large module 12 or its respective assembly framework 11.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

What is claimed is:

1. An apparatus for producing hygiene products, comprising plural stations (2) which each include at least partially differing machine components (3) and predominantly independent drives (4), whereby respective ones of the machine components (3) and the drives (4) are assembled together as assembly units on carrier plates (9) and are mountable and securable in a machine frame that comprises vertical upright supports (18) and horizontal connecting struts (17, 19, 20), wherein the assembly units are provided as small modules (10) that each respectively include ones of the machine components (3), the drives (4), and the carrier plates (9), wherein at least some of the small modules are assembled together to form large modules (12) that similarly form large assembly units, and wherein the large modules (12) equipped with the small modules (10) are connectable with one another to form the apparatus including the machine frame, the machine components (3), and their drives (4).

2. An apparatus according to claim 1, wherein each one of the large modules (12) respectively comprises an assembly framework (11) as a carrier.

3. An apparatus according to claim 2, wherein the assembly framework (11) of the large module (12) comprises frame elements (16) oriented crosswise relative to the machine longitudinal direction, with short horizontal struts (17) and with long vertically arranged upright supports (18) as well as longitudinal struts (19, 20) interconnecting the vertically arranged upright supports in the machine longitudinal direction.

4. The apparatus according to claim 3, further comprising at least one L-shaped frame member (21) provided to stand crosswise relative to the machine longitudinal direction between the frame elements (16) which are rectangular, and wherein the frame member (21) comprises a short shank (22) arranged on a floor side and a vertically standing upright strut (23).

5. An apparatus according to claim 4, wherein each one of the rectangular frame elements (16) and the L-shaped frame members (21) is respectively an integral one-piece element.

6. An apparatus according to claim 4, wherein the rectangular frame elements (16) and the L-shaped frame members (21) each respectively have a recess (24) on the floor side, for an air conveying channel (25).

7. An apparatus according to claim 2, wherein the assembly framework (11) of the large module (12) further comprises horizontally and vertically arranged cable channels (27, 29) separately for electrical control lines (28) and for electrical power supply lines (30).

8. An apparatus according to claim 7, wherein the cable channels (27, 29) are assembled from cable channel segments, and the cable channels as well as the cable channel segments are structured in such a manner so as to simultaneously provide a carrying and supporting function.

9. An apparatus according to claim 6, wherein the air conveying channel (25) is arranged in the machine longitudinal direction and simultaneously has a carrying and supporting function.

10. An apparatus according to claim 9, wherein the air conveying channel (25) consists of steel and has a material thickness that is approximately 2.5 mm greater than the material thickness of such a channel without a carrying and supporting function.

11. An apparatus according to claim 8, wherein the cable channels (27, 29) including the cable channel segments consist of steel and have a material thickness that is approximately 2.5 mm greater than the material thickness of such channels without a carrying and supporting function.

12. An apparatus according to claim 2, further comprising electrical cabinets (34) that are arranged at a spacing distance away from and parallel to the assembly frameworks (11/large modules 12), and are connected therewith.

13. An apparatus according to claim 12, further comprising ceiling panels (37) and cable channels (39, 40) having a U-shaped cross-section, which connect the large modules (12) and the electrical cabinets (34).

14. An apparatus according to claim 1, including the carrier plates (9) with a function of carrying the machine components (3) and their drives (4), and further comprising space holder plates (43) without a carrying function.

15. An apparatus according to claim 14, wherein the carrier plates and the space holder plates respectively have at least one of the following grid dimensions:
a) 1200 mm×700 mm
b) 1200 mm×500 mm
c) 1200 mm×230 mm
d) 800 mm×700 mm
e) 800 mm×500 mm
f) 800 mm×230 mm.
